(19) United States
(12) Patent Application Publication
(10) Pub. No.: US 2014/0172767 A1
(43) Pub. Date: Jun. 19, 2014

(54) BUDGET OPTIMAL CROWDSOURCING

(71) Applicant: MICROSOFT CORPORATION, Redmond, WA (US)

(72) Inventors: Xi Chen, Pittsburgh, PA (US); Qihang Lin, Pittsburgh, PA (US); Dengyong Zhou, Redmond, WA (US)

(73) Assignee: MICROSOFT CORPORATION, Redmond, WA (US)

(21) Appl. No.: 13/715,907

(22) Filed: Dec. 14, 2012

(51) Int. Cl. G06N 5/02

(52) U.S. Cl. CPC G06N 5/02
USPC 706/50

(57) ABSTRACT

To optimize the number of correct decisions made by a crowdsourcing system given a fixed budget, tasks for multiple decisions are allocated to workers in a sequence. A task is allocated to a worker based on results already achieved for that task from other workers. Such allocation addresses the different levels of difficulty of decisions. A task also can be allocated to a worker based on results already received for other tasks from that worker. Such allocation addresses the different levels of reliability of workers. The process of allocating tasks to workers can be modeled as a Bayesian Markov decision process. Given the information already received for each item and worker, an estimate of the number of correct labels received can be determined. At each step, the system attempts to maximize the estimated number of correct labels it expects to have given the inputs so far.

### BACKGROUND

Crowdsourcing is a process of providing a task to a large number of individual workers, and using the combined results from the individual workers for that task to make a decision. For example, many workers can be asked to label a training instance for a classifier, and the training instance is assigned a class by inference from the aggregation of the labels received from many workers.

As an example, an image can be annotated with metadata based on the collective inputs of many individuals. Each individual is asked to label an image. An example is indicating whether the image includes a male or female person. If the majority of individuals label the image as including a male person, the image can be tagged with metadata indicating the image is a male person. In general, each task performed by each individual has an associated cost. The cost may or may not include compensation to the individual. These costs can include a variety of costs that are attributable to the performance of each task.

When there are many decisions to be made, e.g., a large number of images to annotate, the tasks for each decision are distributed over the set of available workers. In most applications, tasks typically are assigned randomly among workers, such that the number of workers assigned to tasks is approximately equal for each decision to be made, and each worker is assigned approximately the same number of tasks. For example, each image is assigned approximately the same number of workers, and each worker is assigned approximately the same number of images. Such crowdsourcing can be used to gather training labels to build classifiers for various classification problems, such as image recognition.

### SUMMARY

This Summary is provided to introduce a selection of concepts in a simplified form that are further described below in the Detailed Description. This Summary is intended neither to identify key features of the claimed subject matter, nor to be used to limit the scope of the claimed subject matter.

In practical applications, different decisions have different levels of difficulty, and different workers have different levels of reliability. If the cost of each transaction is the same, then a random assignment of tasks and workers is non-optimal, with respect to the total cost incurred for the number of correct decisions. In particular, easier decisions can be resolved correctly with fewer workers and at lower cost. Similarly, hard decisions can be quickly identified and abandoned, using fewer transactions at a lower cost. Decisions of moderate difficulty can have more tasks allocated to more workers, incurring a slightly higher cost, but improving the likelihood of reaching a correct decision. Given a limited budget, it would be preferable to wisely allocate the budget among the various tasks to that overall accuracy is maximized.

To optimize the number of correct decisions made given a fixed budget, tasks for multiple decisions are allocated to workers in a sequence. A task is allocated to a worker based on results already achieved for that task from other workers. Such allocation addresses the different levels of difficulty of decisions. A task also can be allocated to a worker based on results already received for other tasks from that worker. Such allocation addresses the different levels of reliability of workers.

In one implementation, the process of allocating tasks to workers is modeled as a Bayesian Markov decision process. A prior distribution, representing the likelihood that an item will be correctly labeled, is defined for each item. If variability in worker reliability is modeled, a prior distribution, representing the likelihood that a worker will label an item correctly, also is defined for each worker. Given the information already received for each item and worker, an estimate of the number of correct labels received can be determined. At each step, the system attempts to maximize the estimated number of correct labels it expects to have given the inputs so far.

The equations modeling this optimization process are a form of Bayesian Markov decision model, which can be solved by dynamic programming for problems of small degree. Practical large problems can be solved using an optimistic knowledge gradient approach described herein.

Accordingly, in one aspect, data describing a plurality of decisions is accessed, wherein each decision has an associated task, and each task has an associated cost. Data describing a plurality of individuals is accessed. A task for one of the plurality of decisions and one of the plurality of individuals is selected, based on results already achieved for the tasks as already performed by other of the plurality of individuals, by maximizing an estimated number of correct decisions given a budget. A request to perform the task for the selected decision is delivered to a computer associated with the selected individual. A result for the task is received from the computer associated with the selected individual. The steps of selecting, delivering and receiving are repeated until the budget is exhausted.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of a crowdsourcing system.

FIG. 2 is a data flow diagram illustrating an example implementation of a crowdsourcing system.

FIG. 3 is a flow chart describing an example operation of a crowdsourcing system.

FIG. 4 is a block diagram of an example computing device with which such a crowdsourcing system can be implemented.

FIG. 5 is a pseudo-code description of an algorithm to implement an optimistic knowledge gradient.

FIG. 6 is a pseudo-code description of an algorithm to implement an optimistic knowledge gradient incorporating worker reliability.

### DETAILED DESCRIPTION

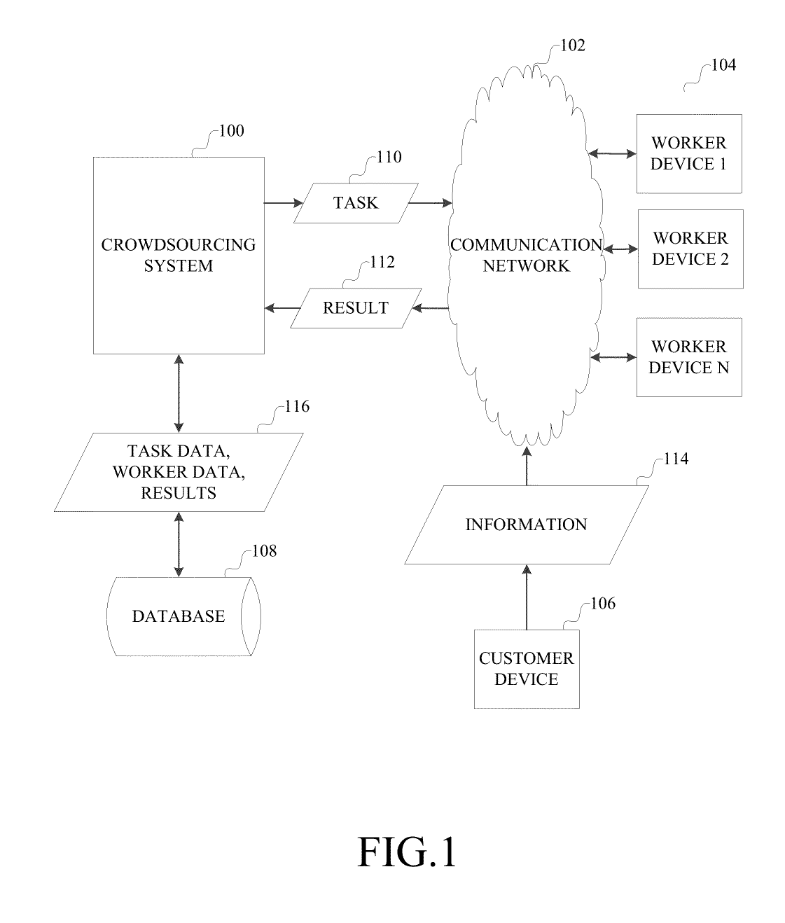

The following section provides an example operating environment for a crowdsourcing system in which budget optimal crowdsourcing of decisions can be implemented. Referring to FIG. 1, a crowdsourcing system 100 connects over a communication network 102 to a plurality of worker devices 104, to communicate with a plurality of individuals (also called “workers” herein), also known as “the crowd.” Each worker is associated with one of the devices 104 to communicate with the crowdsourcing system 100 over the communication network 102.

Devices 104 include but are not limited to general purpose computers, such as desktop computers, notebook computers, laptop computers, tablet computers, slate computers, handheld computers, mobile phones and other handheld devices that can execute computer programs that can communicate over a communication network 102 with a crowdsourcing system 100. Such devices can present an individual with a task to perform and can receive input indicating the individual's response to the task, such as an acceptance of, or a result for, the task.

The crowdsourcing system 100 is implemented using one or more programmable general purpose computers, such as one or more server computers or one or more desktop computers. Such a system 100 can include different computers performing different functions that are described below. The crowdsourcing system 100 is programmed so as to present selected tasks 110 to selected workers, as described below. Further the crowdsourcing system 100 is programmed to receive results 112 for tasks from the workers and use such results in a decision making process.

The computer network 102 can be the internet, but also can be a private or publicly accessible computer network, local or wide area computer network, wired or wireless network, or a form of telecommunications network, or any other communication network for enabling communication between the crowdsourcing system 100 and devices 104.

The crowdsourcing system 100 also can connect to a customer device 106 over the communication network 102. The customer device, similar to devices 104, can be any computing device that can communicate over the communication network 102 with the crowdsourcing system 100 to allow the user to provide information 114 defining a decision to be made, such as by providing an image and a labeling decision to be made about that image.

The crowdsourcing system 100 can maintain a database 108 about the decisions, tasks and workers that the system is managing. The database 108 is a computer with a database management system, with storage in which data can be structured in a many different ways. For example, the data can be structured by using tables of data in a relational database, objects in an object-oriented database, or data otherwise stored in structured formats in data files. The database 108 stores, for each decision to be made such as labeling an image, information 116 describing the task to be performed, workers performing those tasks and results received from those workers. A variety of additional information can be stored about tasks and workers. The information is stored in a manner to facilitate computing an optimization of the estimated number of correct labels given a budget, as described in more detail below. For example, each decision can have a decision identifier and information about the decision, including a reference to a task for the decision. Each task can have a task identifier and information about the task. Each worker can have a worker identifier and information about the worker. Data that describes each task assigned to a worker, and the result provided by the worker for that task also is tracked.

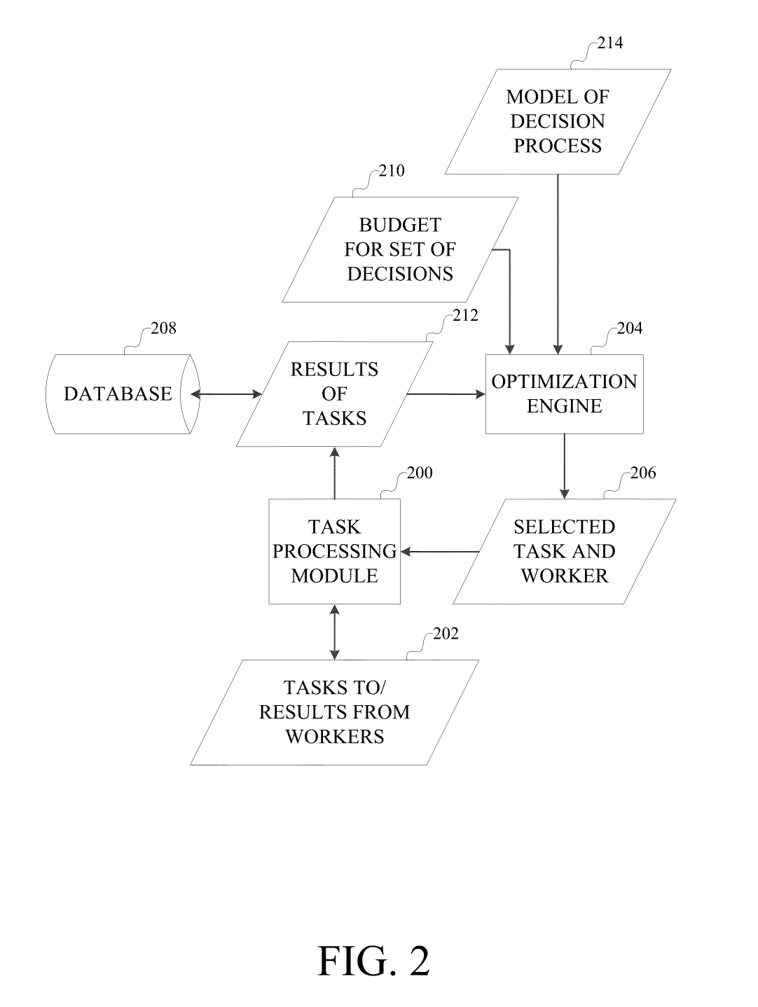

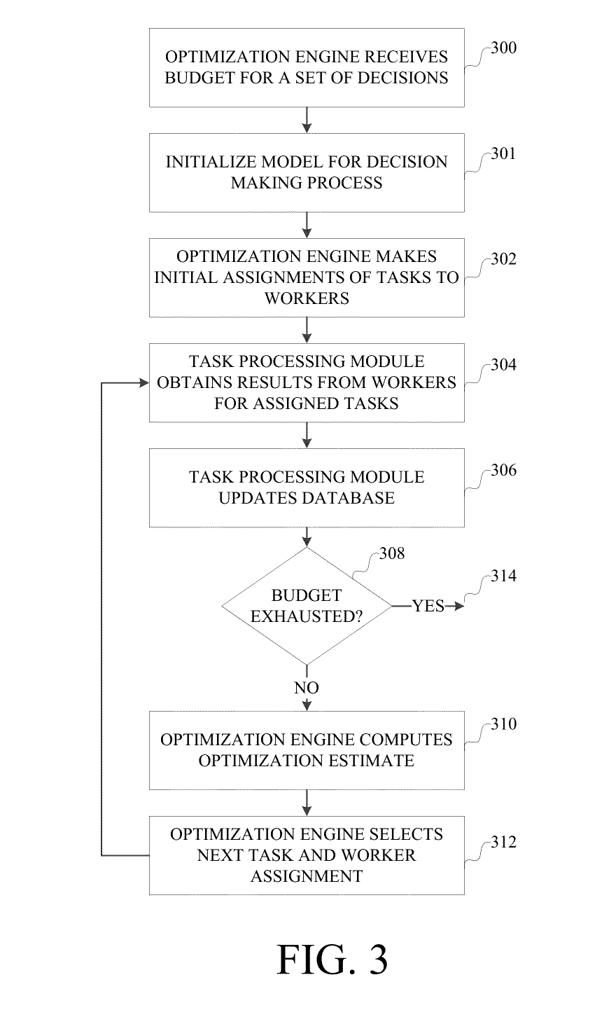

Given this context, an example implementation of the budget optimal crowdsourcing system will be described in more detail in connection with FIGS. 2-3. In FIG. 2, an example implementation of the crowdsourcing system 100 will now be described in connection with a data flow diagram. This example crowdsourcing system 100 includes a task processing module 200 that provides tasks to, and receives results from, the workers as indicated at 202. The selection of a task and a worker is determined by the optimization engine 204, an implementation of which is described in more detail below. The optimization engine 204 provides its results 206 (indicating a selected task and worker) to the task processing module. The task processing module can be implemented in many ways using conventional crowdsourcing technology to manage the communication of task assignments to workers, workers' acceptance of those tasks, and collection of results from the workers. The various data collected by the task processing module 200 is stored in a database 208 (such as described in connection with FIG. 1 above and database 108).

The optimization engine 204 assigns, at each step in a sequence of assignments, a task to a worker by optimizing the estimated number of correct labels for the set of tasks and workers given a budget 210 for a set of decisions. Each decision has a related task for the workers, such as labeling an image. The budget is set for multiple decisions, e.g., multiple images which workers will label. While the following description provides an example of one set of workers and tasks with one budget, it should be understood that the system can manage multiple sets of tasks and workers with different budgets. At each step, the optimization engine accesses data 212, from the database 208, which is relevant to the set of tasks, workers and budget that the optimization engine is currently trying to optimize.

The optimization engine retrieves data 212 from the database 208, including but not limited to data about the results of previously assigned tasks. The optimization engine uses a model 214 of the decision process to optimize an estimated number of correct labels given the budget 210 for the set of decisions to be made. An example model 214 and implementation of the optimization engine 204 is described in more detail below.

In general, the optimization process is based on the observation that different decisions have different levels of difficulty, and different workers have different levels of reliability. If the cost of each transaction is the same, then a random assignment of tasks and workers is non-optimal, with respect to the total cost incurred for the number of correct decisions. In particular, easier decisions can be resolved correctly with fewer workers and at lower cost. Similarly, hard decisions can be quickly identified and abandoned, using fewer transactions at a lower cost. Decisions of moderate difficulty can have more tasks allocated to more workers, incurring a slightly higher cost, but improving the likelihood of reaching a correct decision.

To optimize the number of correct decisions made given a fixed budget, tasks for multiple decisions are allocated to workers in a sequence. A task is allocated to a worker based on results already achieved for that task from other workers. Such allocation addresses the different levels of difficulty of decisions. A task also can be allocated to a worker based on results already received for other tasks from that worker. Such allocation addresses the different levels of reliability of workers.

In one implementation, the process of allocating tasks to workers is modeled as a Bayesian Markov decision process. A prior distribution, representing the likelihood that an item will be correctly labeled, is defined for each item. If variability in worker reliability is modeled, a prior distribution, representing the likelihood that a worker will label an item correctly, also is defined for each worker. Given the information already received for each item and worker, an estimate of the number of correct labels received can be determined by calculating posterior distributions given the data already received and the prior distributions. At each step, the system attempts to maximize the estimated number of correct labels it expects to have given the inputs so far.

The equations modeling this optimization process are a form of Bayesian Markov decision model, which can be solved by dynamic programming for problems of small degree. Practical large problems can be solved using an optimistic knowledge gradient approach described herein. Details of an example implementation are provided below.

Referring now to FIG. 3, a flow chart describing a process of using a system such as shown in FIGS. 1 and 2 will now be described.

The crowdsourcing system provides tasks for multiple decisions to multiple workers, with a budget. Thus, the optimization engine receives 300 a budget for a set of decisions. A model for the decision making process is initialized 301. The optimization engine then makes 302 initial assignments of tasks to workers. Such initial assignments can be made in any manner to provide an initial result for each task from one of the workers, and can be performed by any module in addition to or instead of the optimization engine.

The initial assignments are provided to the task processing module, which obtains 304 results from the workers for the assigned tasks. The task processing module then updates 306 the database with the received results. If the budget has been exhausted, as determined at 308, the process ends as indicated at 314, and decisions can be made based on the results for the tasks performed by the workers.

If the budget has not yet been exhausted, then the optimization engine computes 310 an optimization of the expected number of correct labels given the results of the tasks so far. An example optimization is described below. Given this optimization, the optimization engine selects 312 the next task and worker assignment, and provides the assignment to the task processing module, and the steps 304 through 312 repeat until the budget is exhausted.

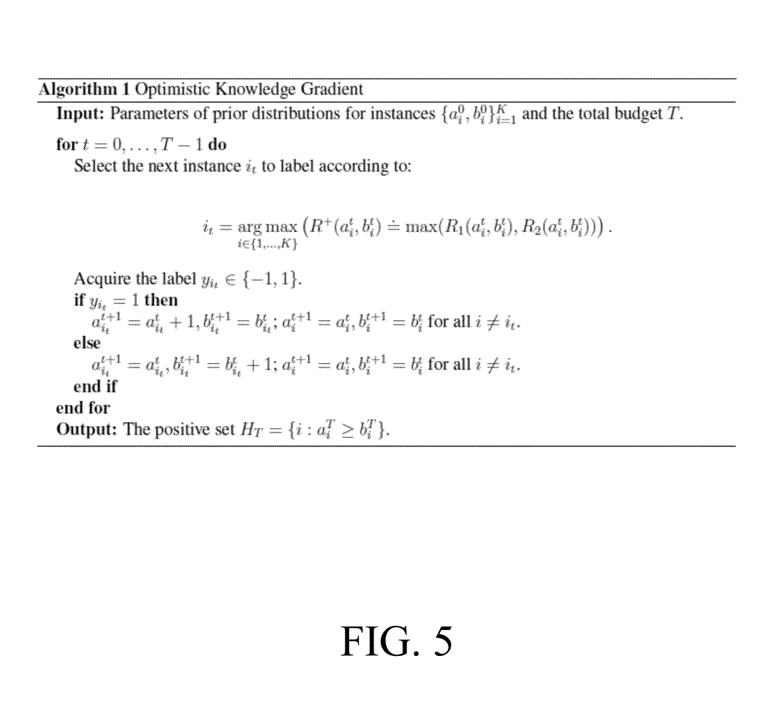

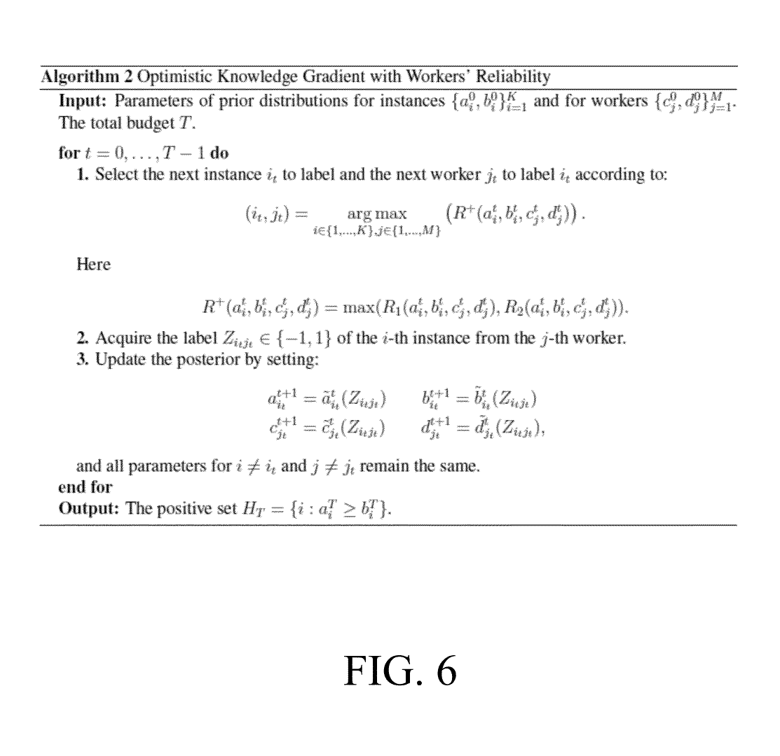

Having now described the general operation of such a crowdsourcing system, a specific example of the decision model, as a Bayesian Markov decision process, and its optimization using an optimal gradient process, will now be described in more detail in connection with FIGS. 5 and 6. This process can be implemented using one or more computer programs that has access to the crowdsourcing data as described above.

In this example implementation, the decision is a form of binary classification with K instances, each instance i for 1≦i≦K has its own soft-label (denoted by θᵢ), which is the underlying probability of being the positive class. The unknown soft-label θᵢ quantifies the difficultly for labeling the i-th instance. In particular, when θᵢ is close to 1 or 0, the true class can be easily identified and thus a few labels are enough. While when θᵢ is close to 0.5, the instance is ambiguous and labels from the crowd could be significantly inconsistent. The first problem is how to accurately estimate θᵢ.

Given the limited amount of budget, to maximize the overall accuracy with the estimated {θᵢ}^{K}₁₌₁, the system decides whether to spend more budget on ambiguous instances or to simply put those instances aside to save money for labeling other instances. Also, in one implementation, because different workers have different reliabilities, the underlying reliability of workers can be estimated during the labeling process to avoid spending more of the budget on those unreliable workers.

To address these challenges and address the budget allocation problem in crowdsourcing, in one implementation, the decision is assumed to be binary, and workers are assumed to be identical and provide labels according to a Bernoulli distribution with the instance's soft-label θᵢ as its parameter. This assumption is realistic if the crowdsourcing system posts tasks publicly to general worker pools or if the worker turnover is high so that it is hard to identify the reliability of worker.

Now suppose the total budget T≧K is pre-fixed and the cost of asking for a label from the crowd is one. The labeling process can be decomposed into T stages. At each stage t=0, 1, . . . T−1, an instance (denoted as iₜ ∈ {1, 2, . . . , K}) is chosen and its label is acquired from the crowd. Each instance can be chosen in multiple stages. A Bayesian approach is used by introducing a Beta prior for each θᵢ and then updating its posterior distribution each time a new label is collected. When the budget is exhausted, a final inference of the true class for each instance can be determined based on the collected labels. The goal is to dynamically determine the optimal allocation sequence (i₀, . . . , i_{T-1}) so that overall accuracy from the final inference is maximized. Although the final inference accuracy only depends on the posterior distribution of θᵢ in the final stage, this can be decomposed as a sum of stage-wise rewards, each of which represents how much the inference accuracy can be improved by updating the posterior distributions with one more label. Therefore, the problem can be formulated as a T-stage Markov Decision Process (MDP) using the parameters of posterior distributions as the state variables.

An implementation of such a model for binary classification is the following. Suppose that there are K instances and each one is associated with a true label Zᵢ ∈ {1, −1} for 1≦i≦K and denote the positive set by H*={i: Zᵢ=1}. Moreover, each instance has an underlying unknown probability of being labeled as positive, denoted as θᵢ ∈ [0, 1]. This means, each time a label is received from the crowd for the i-th instance (denoted by Yᵢ ∈ {1, −1}), Yᵢ is assumed to follow a Bernoulli distribution with the parameter θᵢ, i.e, Pr(Yᵢ=1)=θᵢ and Pr(Yi=−1)=1−θᵢ. It is also assumed that θᵢ≧0.5 when Zᵢ=1 and θᵢ<0.5 when Zᵢ=−1 (i.e., H*={i:θᵢ≧0.5}) so that A, can be treated as the soft label of the i-th instance. At this moment, all workers from the crowd are assumed to be identical so that the distribution of Yᵢ only depends on the soft label of the instance but not on which worker gives the label.

Given such a model, budget allocation using a Bayesian approach will now be described. The underlying soft label A, is drawn from a known Beta prior distribution Beta(a⁰ᵢ, b⁰ᵢ). This can be interpreted as having a⁰ᵢ positive and b⁰ᵢ negative pseudo-labels for the i-th instance at the initial stage. In practice when there is no prior knowledge about each instance, it can be assumed that a⁰ᵢ=b⁰ᵢ=1 so that the prior is a uniform distribution.

At each stage t with Beta(a^{t}ᵢ, b^{t}ᵢ) as the current posterior distribution for θᵢ we choose an instance iₜ ∈ A={1, . . . , K} to acquire the label. The crowd provides its label yᵢₜ ∈ {1, 1}, which follows the Bernoulli distribution with the parameter θᵢₜ. By the fact that Beta is the conjugate prior of the Bernoulli distribution, it is known that the posterior distribution of θᵢₜ in the stage t+1 will be updated as Beta(a^{t|1}ᵢₜ, b^{t|1}ᵢₜ)=Beta(a^{t}ᵢₜ+1, b^{t}ᵢₜ) if yᵢₜ=1 and Beta(a^{t|1}ᵢₜ, b^{t+1}ᵢₜ)=Beta(a^{t}ᵢₜ, t^{t}ᵢₜ+1) if yᵢₜ=−1. We put {a^{t}ᵢ, b^{t}ᵢ}^{K}_{i<1} into a K×2 matrix S^{t}, called a state matrix, and let S^{t}ᵢ=(a^{t}ᵢ, b^{t}ᵢ) be the i-th row of S^{t}. The update of the state matrix can be written in a more compact form:

$${S}^{t + 1} = \{ \begin{matrix}{S}^{t} + ( {e}_{{i}_{t}} , 0 ) & if {y}_{{i}_{t}} = 1 ; \\ {S}^{t} + ( 0 , {e}_{{i}_{t}} ) & if {y}_{{i}_{t}} = - 1 ,\end{matrix} \qquad Equation 1$$

where eᵢₜ is a K×1 vector with 1 at the iₜ-th entry and 0 at all other entries. As we can see, {S^{t}} is a Markovian process because S^{t-1} is completely determined by the current state S^{t}, the action iₜ and the obtained label yᵢₜ. It is easy to calculate the state transition probability Pr(yᵢₜ|S^{t}, iₜ), which is the posterior probability that we are in the next state S^{t-1} if we choose it to be labeled in the current state S^{t}:

$$Pr ( {y}_{{i}_{t}} = 1 \vert {S}^{t} , {i}_{t} ) = 𝔼 ( {θ}_{{i}_{t}} \vert {S}^{t} ) = \frac{{a}_{{i}_{t}}^{t}}{{a}_{{i}_{t}}^{t} + {b}_{{i}_{t}}^{t}} , \qquad Equation 2$$

and Pr(yᵢₜ=−1|S^{t}, iₜ)=1−Pr(yᵢₜ=1|S^{t}, iₜ). Given this labeling process, a filtration {Fₜ}^{T}ₜ₌₀, is defined, where Fₜ is the σ-algebra generated by the sample path (i₀, yᵢ₀, . . . , iₜ₋₁; yᵢₜ₋₁). The action iₜ, i.e., the instance to be labeled, is chosen after the historical labeling results are observed up to stage t−1. Hence, it is Fₜ-measurable. The budget allocation policy is defined as a sequence of decisions: π=(i₀, . . . , i_{T-1}).

At the stage T when the budget is exhausted, the true label of each instance is inferred based on the collected labels. In particular, a positive set H_{T} is determined, which maximizes the conditional expected accuracy conditioning on F_{T}:

$${H}_{T} = {argmax}_{H ⋐ \{ 1 , … , K \}} 𝔼 ( {\sum }_{i ∈ H} 1 ( i ∈ {H}^{*} ) + {\sum }_{i ∉ H} 1 ( i ∉ {H}^{*} ) \vert {F}_{T} ) , \qquad Equation 3$$

where 1(·) is the indicator function. We first observe that, for 0≦t≦T, the conditional distribution θᵢ|Fₜ is exactly the posterior distribution Beta(a^{t}ᵢ, b^{t}ᵢ), which depends on the historical sampling results only through S^{t}ᵢ=(a^{t}ᵢ, b^{t}ᵢ). Hence, we define

I(a, b)=Pr(θ≧0.5|θ˜Beta(a, b)),

Pᵢ^{t}=Pr(i ∈ H*|Fₜ)=Pr(θ≧0.5|Sᵢ^{t})=I(aᵢ^{t}, bᵢ^{t}), Equations 4 and 5

The final positive set H_{T} can be determined by the Bayes decision rule. In particular, H_{T}={i:P^{T}ᵢ≧0.5} solves equation (3) and the expected accuracy of the right hand side of equation (3) can be written as Σ^{K}ᵢ₌₁h(P^{T}ᵢ), where h(x)=max(x, 1−x). Also, the construction of H_{T} is based on the majority vote. Namely, I(a, b)>0.5 if and only if a>b, and I(a, b)=0.5 if and only if a=b. Therefore, H_{T}={i:a^{T}ᵢ≧b^{T}ᵢ} solves equation (3).

By viewing a⁰ᵢ and b⁰ᵢ as pseudo counts of 1 s and −1 s, a^{T}ᵢ and b^{T}ᵢ are the total counts of 1 s and −1 s. The estimated positive set H_{T}={i:a^{T}ᵢ≧b^{T}ᵢ} consists of instances with more (or equal) counts of 1 s than that of −1 s. When a⁰ᵢ =b⁰ᵢ H_{T} is constructed exactly according to the majority vote rule.

Therefore, to find the optimal allocation policy which maximizes the expected accuracy, the following optimization problem is solved:

$$\begin{matrix}V ( {S}^{0} ) \dot{=} {sup}_{π} {𝔼}^{π} [ 𝔼 ( {\sum }_{i ∈ {H}_{T}} 1 ( i ∈ {H}^{*} ) + {\sum }_{i ∉ {H}_{T}} 1 ( i ∉ {H}^{*} ) \vert {F}_{T} ) ] \\ = {sup}_{π} {𝔼}^{π} ( {\sum }_{i = 1}^{K} h ( {P}_{i}^{T} ) ) ,\end{matrix} \qquad Eq n . 6$$

where [symbol] ^{π} represents the expectation taken over the sample paths (i₀, yᵢ₀, . . . , iₜ₋₁; yᵢₜ₋₁) generated by a policy π. The second equality is based on rewriting the right hand side of equation (3) as described above, and V(S⁰) is called a value function at the initial state S⁰. The optimal policy π* is any policy it that attains the supremum in equation (6).

To solve the optimization problem in equation (6), it is formulated into a Markov Decision Process (MDP). One way to do so is to use a technique as described in “Sequential bayes-optimal policies for multiple comparisons with a control,” by J. Xie and P. I. Frazier, in a technical report from Cornell University, 2012 (“Xie”), to decompose the final expected accuracy as a sum of stage-wise rewards, as shown below. While the problem in Xie is an infinite-horizon problem which optimizes the stopping time, the problem herein is a finite-horizon problem because the labeling procedure is stopped when the budget T is exhausted.

The expected reward is defined as:

R(S^{t}, iₜ)= [symbol] (h(Pᵢ_{ₜ}^{t})|S^{t}, iₜ), Equation 7

The value function of equation 6 thus becomes:

$$V ( {S}^{0} ) = {G}_{0} ( {S}^{0} ) + {sup}_{π} {𝔼}^{π} ( {\sum }_{t = 0}^{T - 1} R ( {S}^{t} , {i}_{t} ) ) , \qquad Equation 8$$

where G₀(S⁰)=Σ^{K}ᵢ₌₁ h(P⁰ᵢ) and the optimal policy π* is any policy π that attains the supremum.

Because the expected reward in equation (7) only depends on S^{t}ᵢₜ=(a^{t}ᵢₜ, b^{t}ᵢₜ)∈ [symbol] ^{t}₊, we define R(a^{t}ᵢₜ, b^{t}ᵢₜ)=R(S^{t}, iₜ) and use them interchangeably. As a function on [symbol] ²₊, R(a, b) has an analytical representation. In fact, for any state (a, b) of a single instance, the reward of getting a label 1 and a label −1 are:

R₁(a, b)=h(I(a+1, b))−h(I(a, b)),

R₂(a, b)=h(I(a, b+1))−h(I(a, b)). Equations 9 and 10

The expected reward R(a, b)=p₁R₁+p₂R₂ with p₁=a/(a+b) and p2=b/(a+b) are transition probabilities in equation 2. Thus, the maximization problem of equation 6 is formulated as a T-stage Markov Decision Process in equation 8, which is associated with a tuple {T, {S^{t}}, A, Pr(yᵢₜ|S^{t}, iₜ), R(S^{t}, iₜ)}. Here, the state space at the stage t, S^{t}, is all possible states that can be reached at t. Once a label yᵢₜ is collected, one element in S^{t} (either a^{t}ᵢₜ or b^{t}ᵢₜ) will add one. Therefore, we have:

$${S}^{t} = \{ \begin{matrix}{\{ {a}_{i}^{t} , {b}_{i}^{t} \}}_{i = 1}^{K} \text{:} {a}_{i}^{t} \geq {a}_{i}^{0} , {b}_{i}^{t} \geq {b}_{i}^{0} , \\ {\sum }_{i = 1}^{K} ( {a}_{i}^{t} - {a}_{i}^{0} ) + ( {b}_{i}^{t} - {b}_{i}^{0} ) = t\end{matrix} \} . \qquad Equation 11$$

The action space is the set of instances that could be labeled next: A={1, . . . , K}. The transition probability Pr(yᵢₜ|S^{t}, iₜ) is defined in equation (2) and the expected reward at each stage R(S^{t}, iₜ) is defined in equation (7). Moreover, due to the Markovian property of {S^{t}}, it is enough to consider a Markovian policy where iₜ is chosen only based on the state S^{t}.

Given the description of the problem as a Markov Decision Process, dynamic programming, or backward induction, can be used to compute an optimal policy. However, the size of the state space grows exponentially with t; therefore, other computationally efficient solutions are used for larger problems to provide approximately optimal budget allocation policies.

With the decomposed reward function, the problem is essentially a finite-horizon Bayesian multi-armed bandit (MAB) problem. Various techniques for solving such problems can be used. In one implementation described below, an optimistic knowledge gradient technique is used. A knowledge gradient (KG) techniques is a single-step look-ahead policy, which greedily selects the next instance with the largest expected reward:

$${i}_{t} = {argmax}_{i} ( R ( {a}_{i}^{t} , {b}_{i}^{t} ) \dot{=} \frac{{a}_{i}^{t}}{{a}_{i}^{t} + {b}_{i}^{t}} {R}_{1} ( {a}_{i}^{t} , {b}_{i}^{t} ) + \frac{{b}_{i}^{t}}{{a}_{i}^{t} + {b}_{i}^{t}} {R}_{2} ( {a}_{i}^{t} , {b}_{i}^{t} ) ) . \qquad Equation 12$$

This policy corresponds to the first step in a dynamic programming algorithm and hence a knowledge gradient policy is optimal if only one labeling chance is remaining When there is a tie, if the smallest index i is selected, then the policy is referred to as deterministic KG, while if the tie is broken randomly, the policy is referred to randomized KG. However, deterministic KG is not a consistent policy, and randomized KG behaves similar to a uniform sampling policy in many cases. An approximately optimal policy based on KG will now be described, herein called the optimistic knowledge gradient technique.

The stage-wise reward can be viewed as a random variable with a two point distribution, i.e., with the probability p₁=a/(a+b) of being R₁ and the probability p₂=b/(a+b) of being R₂. The KG policy selects the instance with the largest expected reward. However, it is not consistent. Instead, a modified KG policy can select the instance with the largest R⁻=min(R₁, R₂) or R⁺=max(R₁, R₂). The first strategy selects the next instance based on the pessimistic outcome of the reward, and thus we name the policy as “pessimistic knowledge gradient”. On the other hand, the second strategy selects the next instance based on the optimistic outcome of the reward, and thus we name the policy as “optimistic knowledge gradient”. FIG. 5 describes an algorithm to implement an optimistic knowledge gradient technique.

Another way to look at this problem is to consider a framework called “conditional value-at-risk”. In particular, for a random variable X with the support X (e.g., the random reward with the two point distribution), let α-quantile function be denoted as Qₓ(α)=inf{x ∈ X:α≦Fₓ(x)}, where Fₓ(·) is the CDF of X. The value-at-risk VaR_{α}(X) is the smallest value such that the probability that X is less than (or equal to) it is greater than (or equal to) 1−α: VaR_{α}(X)=Qₓ(1−α). The conditional value-at-risk (CVaR_{α}(X)) is defined as the expected reward exceeding (or equal to) VaR_{α}(X). CVaR_{α}(X) can be expressed as:

$${CVaR}_{α} ( X ) = {max}_{( {q}_{1} \geq 0 , {q}_{2} \geq 0 )} {q}_{1} {R}_{1} + {q}_{2} {R}_{2} , \\ s . t . {q}_{1} \leq \frac{1}{α} {p}_{1} , {q}_{2} \leq \frac{1}{α} {p}_{2} , {q}_{1} + {q}_{2} = 1. \qquad Equation 13$$

In this problem, when α=1, CVaR_{α}(X)=p₁R₁+p₂R₂, which is the expected reward; when α→0, CVaR_{α}(X)=max(R₁, R₂), which is used as the selection criterion in optimistic KG. In fact, a more general policy can be to select the next instance with the largest CVaR_{α}(X) with a tuning parameter α ∈ [0, 1]. Thus, the optimistic KG uses max(R₁, R₂) (i.e., α→0 in CVaR_{α}(X)) as the selection criterion.

In a crowdsourcing application, workers' reliability also can be modeled. Assuming that there are M workers, the reliability of the j-th worker can be captured by introducing an extra parameter ρⱼ ∈ [0, 1]. Precisely, let Zᵢⱼ be the label provided by the j-th worker for the i-th instance. Given the true label Zᵢ ∈ {−1, 1}, for any instance i, we define ρⱼ=Pr(Zᵢⱼ=Zᵢ|Zᵢ). Using the total law of probability:

$$\begin{matrix}Pr ( {Z}_{ij} = 1 ) = Pr ( {Z}_{ij} = 1 \vert {Z}_{i} = 1 ) Pr ( {Z}_{i} = 1 ) + \\ Pr ( {Z}_{ij} = 1 \vert {Z}_{i} = - 1 ) Pr ( {Z}_{i} = - 1 ) \\ = {ρ}_{j} {θ}_{i} + ( 1 - {ρ}_{j} ) ( 1 - {θ}_{i} ) .\end{matrix} \qquad Equation 14$$

This model is often called one-coin model. We note that the previous simplified model is a special case of the one-coin model with ρⱼ=1 for all j, i.e., assuming that every worker is perfect and provides a label only according to the underlying soft label of the instance.

It can be assumed that ρⱼ is also drawn from a Beta prior distribution: ρⱼ˜Beta(c⁰ⱼ, d⁰ⱼ). At each stage t, the system decides on both the next instance i to be labeled and the next worker j to label the instance i (we omit t in I, j here for notation simplicity). In other words, the action space A={(i, j):(i, j)∈ {1, . . . , K}×{1, . . . , M}}. Once the decision is made, we observe the label 1 with the probability Pr(Zᵢⱼ=1|θᵢρⱼ)=θᵢρⱼ+(1−θ)(1−ρⱼ) and the label −1 with Pr(Zᵢⱼ=−1|θᵢ, ρⱼ)=(1−θᵢ)ρⱼ+θᵢ(1−ρⱼ), which is the transition probability. Although the likelihood Pr(Zᵢⱼ=−z|θᵢ, ρⱼ) (z ∈ {−1, 1}) can be explicitly written out, the product of the Beta priors of θᵢ and ρⱼ is no longer the conjugate prior of the likelihood and the posterior distribution is approximated. In particular, a variational approximation is adopted by assuming the conditional independence of θᵢ and ρⱼ: p(θᵢ, ρⱼ|Zᵢⱼ=z)≈p(θᵢ|Zᵢⱼ=z)p(ρⱼ|Zᵢⱼ=z). We further approximate p(θᵢ|Zᵢⱼ=z) and p(ρⱼ|Zᵢⱼ=z) by two Beta distributions whose parameters are computed using moment matching. Due to the Beta distribution approximation of p(θᵢ|Zᵢⱼ=z), the reward function takes a similar form as in the previous setting and the corresponding approximate policies can be directly applied. An algorithm describing the optimistic knowledge gradient incorporating workers' reliability is provided in FIG. 6. We can further extend it to a more complex two-coin model by introducing a pair of parameters (ρⱼ₁, ρⱼ₂) to model the j-th worker's reliability: ρⱼ₁=Pr(Zᵢⱼ=Zᵢ|Zᵢ=1) and ρⱼ₂=Pr(Zᵢⱼ=Zᵢ|Zᵢ=−1).

This formulation of budget allocation for crowdsourcing can be further extended to incorporate feature information and to provide for multi-class, instead of binary, classification. Optimistic knowledge gradient techniques can be applied to these extensions to provide an approximately optimal selection policy.

For incorporating feature information, if each instance is associated with a feature vector xᵢ ∈ R^{p}, the feature information can be used by assuming:

$${θ}_{i} = σ ( 〈 w , {x}_{i} 〉 ) \dot{=} \frac{exp \{ 〈 w , {x}_{i} 〉 \}}{1 + exp \{ 〈 w , {x}_{i} 〉 \}} , \qquad Equation 15$$

where w is drawn from a Gaussian prior N(μ₀, Σ₀). At the t-th stage with the current state (μₜ, Σₜ), an instance iₜ is determined and its label yᵢₜ is acquired. Then the posterior μₜ₊₁ and Σₜ₊₁ is updated using the Laplace method as in Bayesian logistic regression.

For incorporating multi-class classification, with C different classes, it is assumed that the i-th instance is associated with a probability vector θᵢ=(θᵢ₁, . . . , θ_{iC}), where θ_{iC} is the probability that the i-th instance belongs to the class c and Σ^{C}ᵢ₌₁ θ_{ic}=1. It is assumed that θᵢ has a Dirichlet prior θᵢ˜Dir(α⁰ᵢ) and the initial state S⁰ is a K×C matrix with α⁰ᵢ as its i-th row. At each stage t with the current state S^{t}, an instance iₜ to label is determined and its label yᵢₜ ∈ {1, . . . , C} is collected, which follows the categorical distribution:

p(yᵢ_{ₜ})=Π_{c=1}^{C}θᵢ_{ₜ}_{c}^{t(yt}^{ₜ}^{=c)} Equation 16

Since the Dirichlet is the conjugate prior of the categorical distribution, the next state induced by the posterior distribution is S^{t+1}ᵢₜ=S^{t}ᵢₜ+δyᵢₜ and S^{t+1}ᵢ=S^{t}ᵢ for all i≠iₜ. Here δ_{c} is a row vector with one at the c-th entry and zeros at all other entries. The transition probability is represented by the following:

$$Pr ( {y}_{{i}_{t}} = c \vert {S}^{t} , {i}_{t} ) = 𝔼 ( {θ}_{{i}_{t} c} \vert {S}^{t} ) = \frac{{α}_{{i}_{t} c}^{t}}{{\sum }_{c = 1}^{C} {α}_{{i}_{t} c}^{t}} . \qquad Equation 17$$

The true set of instances in class c is denoted by H*_{c}={i:θ_{ic}≧θ_{ic′}, ∀c′≠c}. At the final stage T, the estimated set for class c is H^{T}_{c}={i:P^{T}_{ic}≧P^{T}_{ic′}, ∀c′≠c}, where P^{T}_{ic}=Pr(i ∈ H*_{c}|Fₜ)=Pr(θ_{ic}≧θ_{ic′}, ∀c′≠c|S^{t}). If there is an i that belongs to more than one H^{T}_{c}, it is assigned to the one with the smallest index c so that {H^{T}_{c}}^{C}_{c-1} forms a partition of {1, . . . , K}. Let P^{t}ᵢ=(P^{t}ᵢ₁, . . . , P^{t}_{iC}) and h(P^{t}ᵢ)=max_{1≦c≦C}P^{t}_{ic}. The expected reward takes the form of:

R(S^{t}, iₜ)=E(h(Pᵢ_{ₜ}ⁱ⁺¹)−h(Pᵢ_{ₜ}^{t})″S^{t}, iₜ). Equation 18

With the reward function in place, the problem can be formulated into a Markov Decision Process, for which dynamic programming can obtain an optimal policy and optimistic knowledge gradient can be used to compute an approximate policy. To efficiently compute this reward function, it is rewritten as follows:

$$R ( α ) = {\sum }_{c = 1}^{C} \frac{{α}_{c}}{{\sum }_{\tilde{c} = 1}^{C} {α}_{\tilde{c}}} h ( I ( α + {δ}_{c} ) ) - h ( I ( α ) ) . \qquad Equation 19$$

Here, δ_{c} is a row vector of length C with one at the c-th entry and zeros at all other entries; and I(α)=(I₁(α), . . . , I_{C}(α)) where:

I_{c}(α)=Pr(θ_{c}≧θ_{c}, ∀\tilde{c}≠c|θ˜Dir(α)). Equation 20

This equation for I_{c}(α) can be rewritten as a one-dimensional integration as follows:

$$\begin{matrix}{I}_{c} α = {\int }_{0 \leq {x}_{1} \leq {x}_{c}} … {\int }_{{x}_{c} \geq 0} … {\int }_{0 \leq {x}_{C} \leq {x}_{c}} {\prod }_{c = 1}^{C} \\ {f}_{Gamma} ( {x}_{c} ; {α}_{c} , 1 ) d {x}_{1} … d {x}_{C} \\ = {\int }_{{x}_{c} \geq 0} {f}_{Gamma} ( {x}_{c} ; {α}_{c} , 1 ) {\prod }_{\tilde{c} \neq c} {F}_{Gamma} ( {x}_{c} ; {α}_{\tilde{c}} , 1 ) d {x}_{c} ,\end{matrix} \qquad Equation 21$$

where f_{Gamma}(x; α_{c}, 1) is the density function of a Gamma distribution with the parameter (α_{c}, 1) and F_{Gamma}(x_{c}; α_{\tilde{c}}, 1) is the CDF of Gamma distribution at x_{c} with the parameter (α_{\tilde{c}}, 1). In many computer programs, F_{Gamma}(x_{c}; α_{\tilde{c}}, 1) can be calculated efficiently without an explicit integration.

A Dirichlet distribution can be used to model workers reliability in such a multi-class setting. Also, using multi-class Bayesian logistic regression, features can be incorporated into this multi-class setting.

It should be understood that a variety of other techniques can be used to find a policy to maximize an estimated number of correct decisions given a budget.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

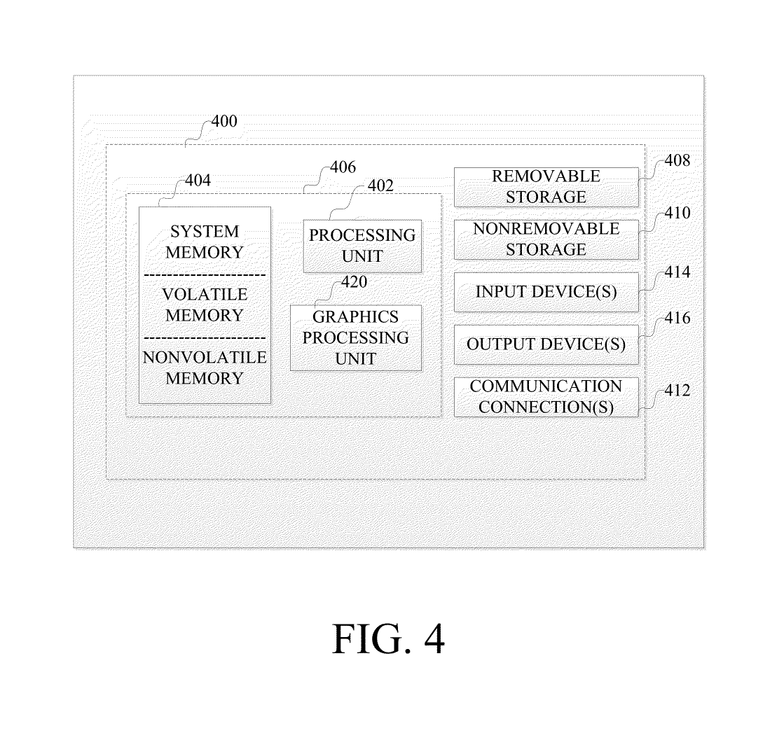

FIG. 4 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 4, an example computing environment includes a computing machine, such as computing machine 400. In its most basic configuration, computing machine 400 typically includes at least one processing unit 402 and memory 404. The computing device may include multiple processing units and/or additional co-processing units such as graphics processing unit 420. Depending on the exact configuration and type of computing device, memory 404 may be volatile (such as RAM), non-volatile (such as ROM, flash memory, etc.) or some combination of the two. This most basic configuration is illustrated in FIG. 4 by dashed line 406. Additionally, computing machine 400 may also have additional features/functionality. For example, computing machine 400 may also include additional storage (removable and/or non-removable) including, but not limited to, magnetic or optical disks or tape. Such additional storage is illustrated in FIG. 4 by removable storage 408 and non-removable storage 410. Computer storage media includes volatile and nonvolatile, removable and non-removable media implemented in any method or technology for storage of information such as computer program instructions, data structures, program modules or other data. Memory 404, removable storage 408 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 400. Any such computer storage media may be part of computing machine 400.

Computing machine 400 may also contain communications connection(s) 412 that allow the device to communicate with other devices. Communications connection(s) 412 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 400 may have various input device(s) 414 such as a keyboard, mouse, pen, camera, touch input device, and so on. Output device(s) 416 such as a display, speakers, a printer, and so on may also be included. All of these devices are well known in the art and need not be discussed at length here. The input and output devices may be part of a natural user interface. A natural user interface (“NUI”) may be defined as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Specific categories of NUI technologies on which Microsoft is working include touch sensitive displays, voice and speech recognition, intention and goal understanding, motion gesture detection using depth cameras (such as stereoscopic camera systems, infrared camera systems, rgb camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

The crowdsourcing system, and its components such as shown in FIG. 2, may be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

Given the various modules in FIGS. 1 and 2, any of the connections between the illustrated modules can be implemented using techniques for sharing data between operations within one process, or between different processes on one computer, or between different processes on different processing cores, processors or different computers, which may include communication over a computer network and/or computer bus. Similarly, steps in the flowcharts can be performed by the same or different processes, on the same or different processors, or on the same or different computers. Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process, comprising:
accessing data describing a plurality of decisions, each decision having an associated task, each task having an associated cost;
accessing data describing a plurality of individuals;
selecting a task for one of the plurality of decisions and one of the plurality of individuals based on results already achieved for the tasks as already performed by other of the plurality of individuals, by maximizing an estimated number of correct decisions given a budget;
delivering a request to perform the task for the selected decision to a computer associated with the selected individual;
receiving a result for the task from the computer associated with the selected individual; and
repeating the steps of selecting, delivering and receiving until the budget is exhausted.

2. The computer-implemented process of claim 1, wherein the decisions have a variety of levels of difficulty.

3. The computer-implemented process of claim 1, wherein the individuals have a variety of levels of reliability.

4. The computer-implemented process of claim 1, wherein the result for a task is selected from a binary set of candidate results.

5. The computer-implemented process of claim 1, result for a task is selected from a finite, multiclass set of candidate results.

6. The computer-implemented process of claim 1, wherein maximizing an estimated number of correct decisions includes computing a Bayesian Markov decision process.

7. The computer-implemented process of claim 6, wherein computing comprises computing an optimistic knowledge gradient.

8. An article of manufacture comprising:
a computer storage medium;
computer program instructions stored on the computer storage medium which, when processed by a processing device, instruct the processing device to perform a process comprising:
accessing data describing a plurality of decisions, each decision having an associated task, each task having an associated cost;
accessing data describing a plurality of individuals;
selecting a task for one of the plurality of decisions and one of the plurality of individuals based on results already achieved for the tasks as already performed by other of the plurality of individuals, by maximizing an estimated number of correct decisions given a budget;
delivering a request to perform the task for the selected decision to a computer associated with the selected individual;
receiving a result for the task from the computer associated with the selected individual; and
repeating the steps of selecting, delivering and receiving until the budget is exhausted.

9. The article of manufacture of claim 8, wherein the decisions have a variety of levels of difficulty.

10. The article of manufacture of claim 8, wherein the individuals have a variety of levels of reliability.

11. The article of manufacture of claim 8, wherein the result for a task is selected from a binary set of candidate results.

12. The article of manufacture of claim 8, wherein the result for a task is selected from a finite, multiclass set of candidate results.

13. The article of manufacture of claim 8, wherein maximizing an estimated number of correct decisions includes computing a Bayesian Markov decision process.

14. The article of manufacture of claim 13, wherein computing comprises computing an optimistic knowledge gradient.

15. A computer system comprising:
a database including storage that stores results for tasks performed by workers;
a task management module configured to connect to a computer network to manage communication of tasks to workers and receipt of results from works, and configured to access the database to store the results of tasks performed by workers;
an optimization engine configured to access the database and manage assignments of tasks to workers by sequentially selecting a task for a worker based on results already achieved for the tasks as already performed by other workers, by maximizing an estimated number of correct decisions given a budget.

16. The computer system of claim 15, wherein the decisions have a variety of levels of difficulty.

17. The computer system of claim 15, wherein the result for a task is selected from a binary set of candidate results.

18. The computer system of claim 15, wherein the result for a task is selected from a finite, multiclass set of candidate results.

19. The computer system of claim 15, wherein maximizing an estimated number of correct decisions includes computing a Bayesian Markov decision process.

20. The computer system of claim 19, wherein computing comprises computing an optimistic knowledge gradient.
